(19) United States
(12) Patent Application Publication
(10) Pub. No.: US 2026/0092824 A1
(43) Pub. Date: Apr. 2, 2026

(54) SEMICONDUCTOR HYDROGEN PRESSURE SENSOR AND METHOD FOR MANUFACTURING SAME

(71) Applicant: MITSUBISHI ELECTRIC MOBILITY CORPORATION, Tokyo (JP)

(72) Inventor: Eiji YOSHIKAWA, Tokyo (JP)

(73) Assignee: MITSUBISHI ELECTRIC MOBILITY CORPORATION, Tokyo (JP)

(21) Appl. No.: 19/113,094

(22) PCT Filed: Feb. 21, 2023
(86) PCT No.: PCT/JP2023/006252

§ 371 Date: Mar. 19, 2025

(51) Int. Cl. G01L 19/06; G01L 19/00

(52) U.S. Cl. CPC G01L 19/06; G01L 19/0061

(57) ABSTRACT

A semiconductor hydrogen pressure sensor includes: a semiconductor pressure detection element which receives a pressure of a measurement target medium containing hydrogen and electrically outputs a value according to an absolute pressure of the measurement target medium; a bonding wire extending from a terminal of the semiconductor pressure detection element; and a protection film continuously coating parts of the semiconductor pressure detection element and the bonding wire that are exposed to the measurement target medium.

### TECHNICAL FIELD

The present disclosure relates to a semiconductor hydrogen pressure sensor and a method for manufacturing the same.

### BACKGROUND ART

In a fuel cell system practically used in a mobile object such as an automobile, in order to optimize electric generation efficiency of a fuel cell, it is necessary to accurately control the supply amounts of air and hydrogen which is fuel. In order to accurately control the supply amounts of air and hydrogen, a pressure sensor for accurately measuring the pressures of these gases in real time is required. In the fuel cell system, a semiconductor hydrogen pressure sensor which is provided near the fuel cell and measures the pressures of hydrogen, mixture gas thereof, and air supplied to the fuel cell or off-gas such as vapor discharged from the fuel cell, is developed and put into practical use.

As the fuel cell system, there are various types, For example, in a case of a polymer electrolyte fuel cell (PEFC) system practically used for a mobile object such as an automobile, the fuel cell system includes an anode sub system and a cathode sub system. The anode sub system supplies hydrogen which is fuel to a fuel cell stack. The cathode sub system supplies oxygen contained in the air to the fuel cell stack. The oxygen reacts with the fuel.

In such a fuel cell system, in order to optimize electric generation efficiency, the hydrogen amount needs to be controlled in the anode sub system and the air amount needs to be controlled in the cathode sub system so that these amounts become appropriate amounts at all times. Therefore, the semiconductor hydrogen pressure sensor for measuring the pressure of a medium such as hydrogen entering/exiting the fuel cell stack is one of key components that greatly influence efficiency of the fuel cell system. The semiconductor hydrogen pressure sensor for measuring the pressure of hydrogen is required to not only accurately measure the pressure as its original function but also have high hydrogen reliability. In particular, in the anode sub system, the semiconductor hydrogen pressure sensor needs to cope with hydrogen having purity of up to 100% without maintenance over the system lifespan. Therefore, having high reliability against hydrogen is an essential condition in applying the semiconductor hydrogen pressure sensor to the fuel cell system. Meanwhile, in the cathode sub system, in principle, a medium to be treated is air. However, in actuality, a medium containing hydrogen due to a cross-leakage phenomenon or the like in the fuel cell stack is a target of pressure measurement, and therefore reliability against hydrogen is required also in the semiconductor hydrogen pressure sensor provided in the cathode sub system, However, while there is such requirement of reliability, hydrogen has a characteristic of reducing reliability of the semiconductor pressure sensor. This characteristic is a characteristic intrinsic to hydrogen that hydrogen easily passes through various materials and embrittles many metals. Thus, in the semiconductor pressure sensor relevant to hydrogen, there has been a problem over a long time in achieving both of accurate measurement of a pressure and establishment of reliability.

A configuration of a conventional hydrogen pressure sensor for coping with the above problem will be described. The pressure sensor includes a metal pressure-reception diaphragm which is made of stainless steel or the like and receives the pressure of hydrogen, an oil sealed portion provided on the rear side of the metal pressure-reception diaphragm, and a pressure detection element which detects stress produced by the pressure received by the metal pressure-reception diaphragm via oil at the rear of the oil sealed portion and converts the stress to an electric signal. In the conventional pressure sensor, an indirect measurement method in which the pressure detection element detects stress propagated via oil is adopted. A main reason for adopting such an indirect measurement method is that there has been no pressure detection element for which practical hydrogen reliability has been verified under an environment directly exposed to hydrogen. Therefore, it has been necessary to have a structure for physically isolating hydrogen and the pressure detection element from each other. While such a measure is taken for the pressure detection element, hydrogen embrittlement of the metal pressure-reception diaphragm which is directly exposed to hydrogen is addressed by performing treatment such as baking or coating on the metal pressure-reception diaphragm so as to prevent embrittlement of metal, With this configuration, a certain reliability measure is taken for the hydrogen pressure sensor as a whole.

In the conventional hydrogen pressure sensor, reliability against hydrogen is established by the above configuration. However, since the above configuration is a configuration in which the pressure of hydrogen is indirectly measured via oil using the metal pressure-reception diaphragm, there have remained a problem that, in principle, it is very difficult to achieve size reduction and weight reduction of the hydrogen pressure sensor as a whole and a problem that the measurement principle in which the pressure is indirectly detected hampers enhancement of measurement accuracy.

A configuration of a hydrogen pressure sensor to solve the above problems is disclosed (see, for example, Non-Patent Document 1). In Non-Patent Document 1, a semiconductor hydrogen pressure sensor has a structure in which a semiconductor pressure detection element which directly receives a hydrogen pressure by a single-crystal silicon diaphragm which has no risk of hydrogen embrittlement and has a small size and a small weight, instead of a metal material such as stainless steel, is mounted to a housing made of resin. This disclosed semiconductor hydrogen pressure sensor has been put into practice, and with this configuration, a high-accuracy hydrogen pressure sensor that achieves both of high hydrogen reliability and significant weight reduction is realized.

The semiconductor pressure detection element provided in a pressure-reception chamber is covered with gel over the entire surface. By covering the semiconductor pressure detection element with gel, corrosion of the semiconductor pressure detection element due to an acid or the like is prevented. Since a metal member such as stainless steel is not used for the housing and the pressure-reception diaphragm, the hydrogen pressure sensor is significantly reduced in size and weight. In addition, since the semiconductor pressure detection element directly receives a hydrogen pressure not via oil and measures the absolute pressure of hydrogen, hydrogen can be accurately measured, resulting in high efficiency of the entire system.

### CITATION LIST

### Patent Document

Non-Patent Document 1:“Hydrogen Pressure Sensor for Fuel Cell Electric Vehicles”, Mitsubishi Electric Technical Report, Vol. 96, No. 1, 2022

### SUMMARY OF THE INVENTION

### Problem to be Solved by the Invention

In the case of configuring the semiconductor hydrogen pressure sensor as described above, size reduction, weight reduction, and high accuracy of the hydrogen pressure sensor can be achieved. However, the applicant has found that, also in the above semiconductor hydrogen pressure sensor, vulnerability to be solved due to a direct pressure reception method using the semiconductor pressure detection element remains under a limited complex condition in which a specific mounting part in the system, a specific system operation condition, a specific surrounding environmental condition, and the like are combined. The found vulnerability will be described below.

The gel covering the semiconductor pressure detection element has a high protection effect even if a measurement target medium is a corrosive liquid such as an acid, under a high temperature and an ordinary pressure. However, under a specific complex condition in which a high temperature, a high humidity, and a high pressure are combined, the measurement target medium is absorbed into the gel at a certain rate although the rate is very slow on a several-day basis. Even after the measurement target medium is absorbed into the gel once, if supply of the measurement target medium is stopped by stoppage of the system or the like, the measurement target medium is released from the gel. A risk that leads to a problem begins to arise in a case where, when specific conditions about the environment at the part where the semiconductor hydrogen pressure sensor is mounted, the state of the measurement target medium, and the system operation are combined, vapor contained in the measurement target medium absorbed into the gel condenses on surfaces of the semiconductor pressure detection element having a relatively slightly low temperature, a bonding wire connected to the semiconductor pressure detection element, and the like.

Parts on which condensed droplets are deposited include conductive portions. Specifically, conductive portions are an entire surface of a bonding wire, an outer periphery of a bonding pad on the semiconductor pressure detection element for electrically connecting a bonding wire and the semiconductor pressure detection element, and a bonding portion between a bonding wire and a lead frame connected to outside. Even if condensation has occurred, there is no problem as long as the system is stopped and power is not being supplied to the semiconductor hydrogen pressure sensor. However, if the system operates with the condensation not eliminated and power is supplied to the semiconductor pressure detection element, via droplets condensed in contact with the conductive portions, a potential difference arises between each conductive portion and another conductive part, so that electrolysis of the droplets begins. It has been confirmed that, through the above phenomenon, corrosion of the conductive portions such as wiring and bonding wires on the semiconductor pressure detection element begins. Even though this phenomenon occurs under a limited condition and progresses at a very slow rate, the phenomenon is repeated and corrosion grows cumulatively, depending on the operation condition of the system. Thus, there is a risk that such a conductive part results in breakage before the system reaches the end of the expected life.

Any types of gel materials for potting have such a characteristic of absorbing and releasing gas or the like, and this characteristic is intrinsic to gel materials. Therefore, a gel material having such a characteristic of not absorbing gas at all or absorbing gas only in a range of not influencing the expected life of the system needs to be used for the semiconductor hydrogen pressure sensor. However, at present, there is no gel material that completely stops a gas absorbing/releasing phenomenon under every medium condition assumed in the system. Therefore, there is a problem that droplets are deposited on the conductive portions in the semiconductor hydrogen pressure sensor.

Accordingly, an object of the present disclosure is to provide a semiconductor hydrogen pressure sensor having high accuracy and high reliability while having a reduced size and a reduced weight, and a method for manufacturing the same.

### Means to Solve the Problem

A semiconductor hydrogen pressure sensor according to the present disclosure includes: a semiconductor pressure detection element which receives a pressure of a measurement target medium containing hydrogen and electrically outputs a value according to an absolute pressure of the measurement target medium; a bonding wire extending from a terminal of the semiconductor pressure detection element; and a protection film continuously coating parts of the semiconductor pressure detection element and the bonding wire that are exposed to the measurement target medium.

A method for manufacturing a semiconductor hydrogen pressure sensor according to the present disclosure includes: a member preparation step of preparing a bonding wire and a semiconductor pressure detection element which receives a pressure of a measurement target medium and electrically outputs a value according to an absolute pressure of the measurement target medium; a connection step of electrically connecting the bonding wire to the semiconductor pressure detection element; and a film formation step of continuously coating parts of the semiconductor pressure detection element and the bonding wire that are exposed to the measurement target medium, with a protection film.

### Effect of the Invention

The semiconductor hydrogen pressure sensor according to the present disclosure includes: the semiconductor pressure detection element which receives the pressure of the measurement target medium containing hydrogen and electrically outputs the value according to the absolute pressure of the measurement target medium; the bonding wire extending from the terminal of the semiconductor pressure detection element; and the protection film continuously coating parts of the semiconductor pressure detection element and the bonding wire that are exposed to the measurement target medium. Thus, even if condensation has occurred on the protection film, droplets are not deposited on conductive portions of the semiconductor pressure detection element and the bonding wire. Therefore, corrosion and breakage of the conductive portions due to electrolysis of the droplets do not occur, whereby the semiconductor hydrogen pressure sensor having high accuracy and high reliability while having a reduced size and a reduced weight can be obtained.

The method for manufacturing the semiconductor hydrogen pressure sensor according to the present disclosure includes: the member preparation step of preparing the bonding wire and the semiconductor pressure detection element which receives the pressure of the measurement target medium and electrically outputs the value according to the absolute pressure of the measurement target medium; the connection step of electrically connecting the bonding wire to the semiconductor pressure detection element; and the film formation step of continuously coating parts of the semiconductor pressure detection element and the bonding wire that are exposed to the measurement target medium, with the protection film. Thus, even if condensation has occurred on the protection film, droplets are not deposited on conductive portions of the semiconductor pressure detection element and the bonding wire. Therefore, corrosion and breakage of the conductive portions due to electrolysis of the droplets do not occur, whereby the semiconductor hydrogen pressure sensor having high accuracy and high reliability while having a reduced size and a reduced weight can be manufactured.

### BRIEF DESCRIPTION OF THE DRAWINGS

FIG. 1 is a sectional view schematically showing a semiconductor hydrogen pressure sensor according to embodiment 1.

FIG. 2 is a sectional view schematically showing a pressure reception chamber of the semiconductor hydrogen pressure sensor according to embodiment 1.

FIG. 3 illustrates effects of the semiconductor hydrogen pressure sensor according to embodiment 1.

FIG. 4 shows a manufacturing process for the semiconductor hydrogen pressure sensor according to embodiment 1.

FIG. 5 is a sectional view showing a major part of a pressure-reception chamber of a semiconductor hydrogen pressure sensor according to embodiment 2.

FIG. 6 shows a manufacturing process for a semiconductor hydrogen pressure sensor according to embodiment 3.

FIG. 7 shows change in residual stress in the semiconductor hydrogen pressure sensor according to embodiment 3.

FIG. 8 is a sectional view schematically showing a pressure-reception chamber of a semiconductor hydrogen pressure sensor according to embodiment 4.

FIG. 9 is a sectional view schematically showing a semiconductor hydrogen pressure sensor according to embodiment 5.

FIG. 10 is a sectional view schematically showing a semiconductor hydrogen pressure sensor according to embodiment 6.

FIG. 11 is a sectional view schematically showing a semiconductor hydrogen pressure sensor in a comparative example.

FIG. 12 is a sectional view schematically showing a pressure-reception chamber of the semiconductor hydrogen pressure sensor in the comparative example.

FIG. 13 shows a state in which droplets are deposited in the pressure-reception chamber of the semiconductor hydrogen pressure sensor in the comparative example shown in FIG. 12.

FIG. 14 is a schematic diagram schematically showing a gas supply system of a fuel cell system.

### DESCRIPTION OF EMBODIMENTS

Hereinafter, a semiconductor hydrogen pressure sensor and a method for manufacturing the same, according to embodiments of the present disclosure, will be described with reference to the drawings. In the drawings, the same or corresponding members or parts are denoted by the same reference characters, to give description.

### Embodiment 1

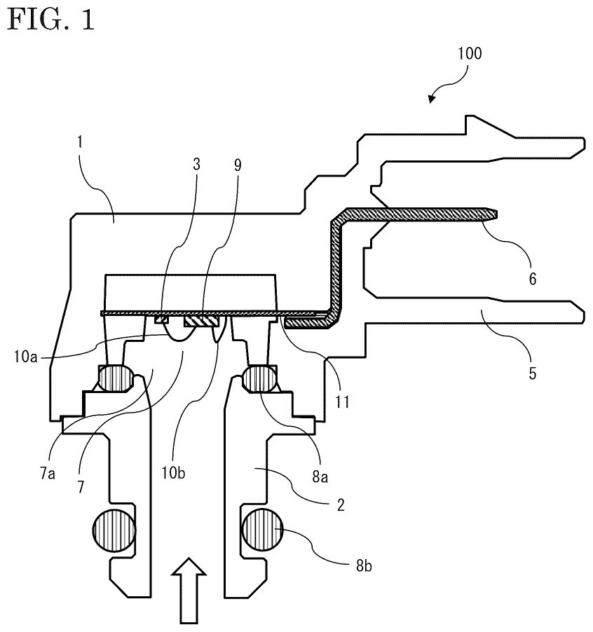

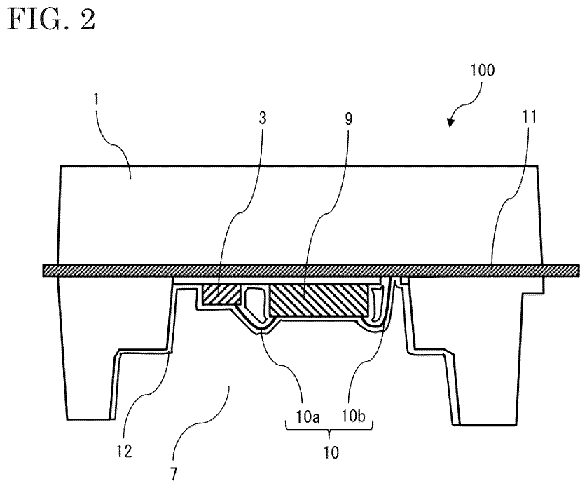

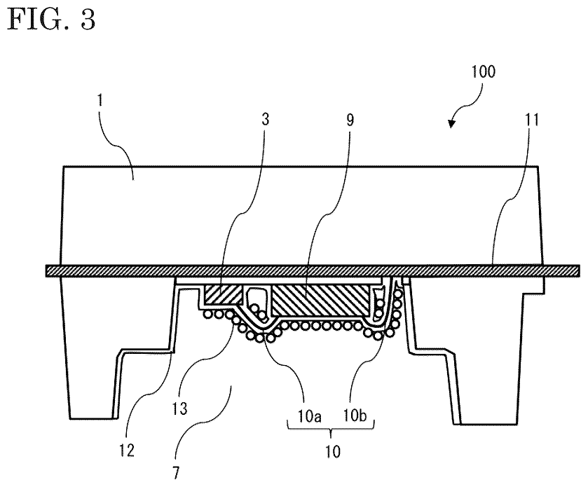

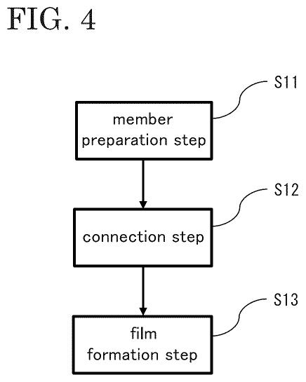

FIG. 1 is a sectional view schematically showing a semiconductor hydrogen pressure sensor 100 according to embodiment 1 with a protection film 12 not shown, FIG. 2 is a sectional view schematically showing a pressure-reception chamber 7 of the semiconductor hydrogen pressure sensor 100, FIG. 3 illustrates effects of the semiconductor hydrogen pressure sensor 100, and FIG. 4 shows a manufacturing process for the semiconductor hydrogen pressure sensor 100 according to embodiment 1. The semiconductor hydrogen pressure sensor 100 is a sensor that directly receives the pressure of a measurement target medium by a semiconductor pressure detection element 3 with another member such as oil not interposed between the detection element and a part for receiving the pressure of the measurement target medium, measures the absolute pressure of the measurement target medium, and outputs the measurement result.

### Semiconductor Hydrogen Pressure Sensor 100

As shown in FIG. 2, the semiconductor hydrogen pressure sensor 100 includes: the semiconductor pressure detection element 3 which receives the pressure of the measurement target medium containing hydrogen and electrically outputs a value according to the absolute pressure of the measurement target medium; a bonding wire 10a extending from a terminal of the semiconductor pressure detection element 3; and the protection film 12 continuously coating parts of the semiconductor pressure detection element 3 and the bonding wire 10a that are exposed to the measurement target medium. In the present embodiment, the semiconductor hydrogen pressure sensor 100 includes a lead frame 11 insert-molded in the pressure-reception chamber 7 which is made of resin and inside which the semiconductor pressure detection element 3 is fixed, and an ASIC 9 as a signal processing circuit which is fixed inside the pressure-reception chamber 7 and which is connected to the semiconductor pressure detection element 3 via the bonding wire 10a and connected to the lead frame 11. In the present embodiment, the protection film 12 continuously coats parts of the semiconductor pressure detection element 3, the bonding wires 10, the ASIC 9, and the pressure-reception chamber 7 that are exposed to the measurement target medium. The bonding wires 10 are wires made of gold, for example.

As shown in FIG. 1, the semiconductor hydrogen pressure sensor 100 further includes the pressure-reception chamber 7 inside which the semiconductor pressure detection element 3 and the ASIC 9 are fixed and which has an opening 7a through which the measurement target medium is taken into the pressure-reception chamber 7, and a connecting pipe 2 which communicates with the pressure-reception chamber 7 via the opening 7a and through which the measurement target medium is taken into the pressure-reception chamber 7 from outside. The measurement target medium is taken into the pressure-reception chamber 7 through the connecting pipe 2 from outside, in a direction of an arrow shown in FIG. 1 In the present embodiment, the measurement target medium is mainly hydrogen. A part of a housing 1 around the pressure-reception chamber 7, the pressure-reception chamber 7, and the connecting pipe 2 are connected via an O ring 8a. The connecting pipe 2 and an external flow path (not shown) for the measurement target medium are connected via an O ring 8b. Thus, a part serving as a flow path for the measurement target medium is sealed.

The pressure-reception chamber 7 is a part surrounding the semiconductor pressure detection element 3 and the ASIC 9, and is a part where the protection film 12 is provided in FIG. 2. The pressure-reception chamber 7 is formed by insert molding in which resin is formed around the lead frame 11 used for transmitting/receiving an electric signal to/from outside. The lead frame 11 is made of metal such as copper. The lead frame 11 and the ASIC 9 is connected by the bonding wire 10b. A part surrounding the pressure-reception chamber 7 and retaining the pressure-reception chamber 7 is the housing 1 of the semiconductor hydrogen pressure sensor 100. The housing 1 is made of resin. The connecting pipe 2 is made of the same material as the housing 1. The housing 1 has a connector portion 5 used for connection with outside. The connector portion 5 has a terminal 6 therein. The terminal 6 is made of metal such as copper. The terminal 6 is electrically connected to the lead frame 11 by solder, for example. An output of the semiconductor pressure detection element 3 is outputted from the terminal 6 to outside via the ASIC 9, In the semiconductor hydrogen pressure sensor 100, the housing 1 and the connecting pipe 2 are made of resin, and the terminal 6 and the lead frame 11 are integrated by resin, so that the size and the weight are reduced.

The semiconductor pressure detection element 3 receives the pressure of the measurement target medium, converts the pressure to an electric signal, and outputs the electric signal. The ASIC 9 has a function of amplifying the electric signal outputted from the semiconductor pressure detection element 3, and compensating for a pressure characteristic detected with respect to a temperature and a pressure. The semiconductor pressure detection element 3 is an element described in Japanese U.S. Pat. No. 6,300,773, for example. The semiconductor pressure detection element 3 is a type in which a hydrogen pressure is directly received by a single-crystal silicon diaphragm and strain of the diaphragm is converted to an electric signal by a piezoresistor provided at an outer periphery of the diaphragm or the like, and has sufficiently high hydrogen reliability in usage under an environment directly exposed to pure hydrogen. The semiconductor pressure detection element 3 has, on its surface, a terminal connected to the bonding wire 10a. In the drawings, only one bonding wire 10a is shown, but the number of bonding wires 10a and the number of terminals may be plural.

### Comparative Example

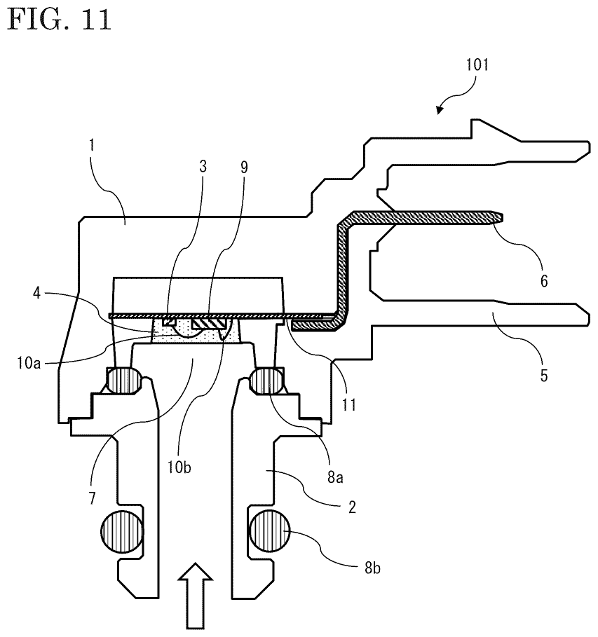

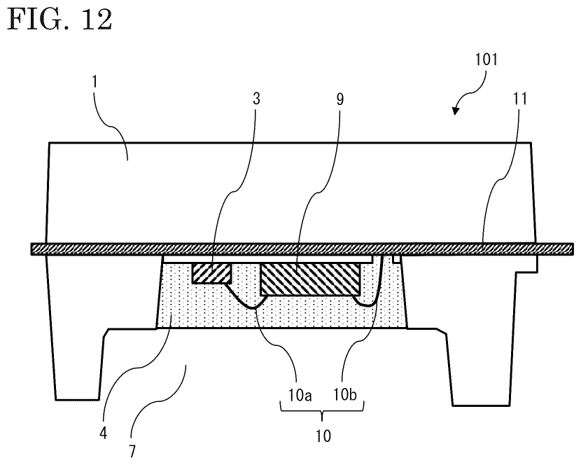

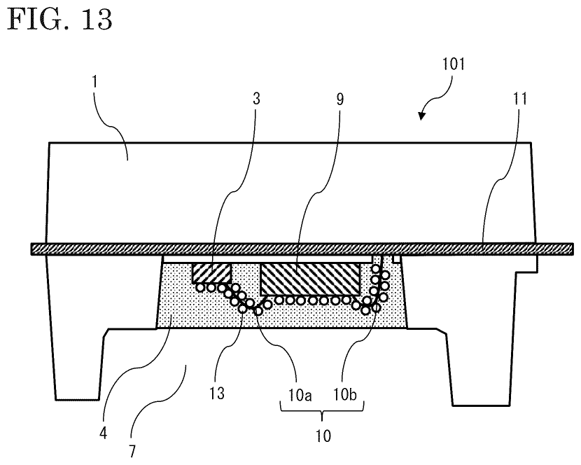

Before description of the protection film 12 which is a major part of the present disclosure, a comparative example will be described. FIG. 11 is a sectional view schematically showing a semiconductor hydrogen pressure sensor 101 in a comparative example, FIG. 12 is a sectional view schematically showing the pressure-reception chamber 7 of the semiconductor hydrogen pressure sensor 101 in the Comparative example, and FIG. 13 shows a state in which droplets 13 are deposited inside the pressure-reception chamber 7 of the semiconductor hydrogen pressure sensor 101 in the comparative example shown in FIG. 12. The semiconductor hydrogen pressure sensor 101 does not have the protection film 12, and the semiconductor pressure detection element 3, the ASIC 9, and the bonding wires 10 provided in the pressure-reception chamber 7 are covered with gel 4, The semiconductor hydrogen pressure sensor 101 is different from the semiconductor hydrogen pressure sensor 100 in that conductive portions of the semiconductor pressure detection element 3, the ASIC 9, and the bonding wires 10 are covered with the gel 4.

The gel 4 covering the semiconductor pressure detection element 3 has a high protection effect even if the measurement target medium is a corrosive liquid such as an acid, under a high temperature and an ordinary pressure. However, under a specific complex condition in which a high temperature, a high humidity, and a high pressure are combined, the measurement target medium is absorbed into the gel 4 at a certain rate although the rate is very slow on a several-day basis. When the environment at the part where the semiconductor hydrogen pressure sensor 101 is mounted, the state of the measurement target medium, and the status of the system operation are combined in a specific condition, vapor contained in the measurement target medium absorbed into the gel 4 can condense on the surfaces of the semiconductor pressure detection element 3 and the like having a relatively slightly low temperature. FIG. 13 shows an example of a state in which condensation has occurred on the surfaces of the semiconductor pressure detection element 3, the ASIC 9, and the bonding wires 10 and the droplets 13 are produced at these parts.

Parts on which the droplets 13 are deposited include conductive portions. Specifically, conductive portions are the entire surfaces of the bonding wires 10, an Outer periphery of a bonding pad which is a terminal on the semiconductor pressure detection element 3 for electrically connecting the bonding wire 10a and the semiconductor pressure detection element 3, and a bonding portion between the lead frame 11 and the bonding wire 10b. Even if condensation has occurred, there is no problem as long as the system is stopped and power is not being supplied to the semiconductor hydrogen pressure sensor 101. However, if the system operates with the condensation not eliminated and power is supplied to the semiconductor hydrogen pressure sensor 101, the conductive portions are each imparted with a potential difference between each conductive portion and another conductive part via the condensed droplets 13 in contact with the conductive portions. Due to the potential difference having arisen, electrolysis of the droplets 13 begins. Through the above phenomenon, corrosion of the conductive portions begins. Even though this phenomenon occurs under a limited condition and progresses at a very slow rate, the phenomenon is repeated cumulatively, depending on the operation condition of the system. Thus, there is a risk that the corroded conductive portion results in breakage before the system reaches the end of the expected life.

If the gel 4 having such a characteristic of not absorbing gas at all or absorbing gas only in a range of not influencing the expected life of the system is used for the semiconductor hydrogen pressure sensor 101, the conductive portions do not result in breakage. However, at present, there is no gel 4 that completely stops a gas absorbing/releasing phenomenon under every medium condition assumed in the system. Therefore, in the semiconductor hydrogen pressure sensor 101, it is important that the conductive portions do not contact with the gel 4 and the droplets 13 are not deposited on the conductive portions.

### Protection Film 12

The protection film 12 which is a major part of the present disclosure will be described. In order that the droplets 13 are not deposited on the conductive portion, the protection film 12 continuously coats parts of the semiconductor pressure detection element 3 and the bonding wire 10 that are exposed to the measurement target medium.

The parts coated with the protection film 12 are not limited thereto. In the present embodiment, as shown in FIG. 2, all the parts where the pressure-reception chamber 7 is formed are coated with the protection film 12. The protection film 12 is a polymer coating film having functions such as repelling water, not allowing passage of vapor, and resisting acid corrosion, and is preferably a parylene film which allows conformal coating, for example. It is preferable that the protection film 12 is formed by chemical vapor deposition (CVD), for example. With the protection film 12 formed by chemical vapor deposition, it is possible to continuously coat not only the surfaces of the conductive portions but also the inner wall of the pressure-reception chamber 7, so as to maximize the effect of coating.

The protection film 12 formed using the above material by the above manufacturing method uniformly extends not only over the exposed surfaces of the coating subjects but also into complicated and fine grooves and holes thereof so as to protect the coating subjects, thus exhibiting very high coating property. In addition, the film thickness can be finely controlled and it is preferable that the film thickness of the protection film 12 is set at 2 to 10 μm. In principle, increasing the film thickness of the protection film 12 naturally enhances the protection effect by the protection film 12. However, as the film thickness of the protection film 12 increases, residual stress of the protection film 12 increases. Therefore, in a case where the film thickness of the protection film 12 is great, an unfavorable influence such as nonlinearity of a strain-sensing characteristic of the piezoresistor increases. In addition, in the case where the film thickness of the protection film 12 is great, the change amount of residual stress due to a high temperature or the like increases during usage of the semiconductor hydrogen pressure sensor 100, leading to increase in change of the detection characteristic of the semiconductor hydrogen pressure sensor 100 over time. In order to avoid such a problem, the film thickness of the protection film 12 is controlled in the above range, whereby improvement in the protection effect by the protection film 12 and maintenance of high-accuracy measurement in the semiconductor hydrogen pressure sensor 100 can be both achieved. In addition, since the semiconductor hydrogen pressure sensor 100 has a configuration in which only the protection film 12 is provided at parts of the semiconductor pressure detection element 3, the bonding wire 10a, and the like provided in the pressure-reception chamber 7, the semiconductor hydrogen pressure sensor 100 is not increased in size and the size and the weight of the semiconductor hydrogen pressure sensor 100 are reduced,

Since the protection film 12 continuously coats parts of the semiconductor pressure detection element 3 and the bonding wire 10a that are exposed to the measurement target medium as described above, even if the droplets 13 are condensed and deposited on the protection film 12 as shown in FIG. 3, the droplets 13 are not deposited on the conductive portions of the semiconductor pressure detection element 3 and the bonding wire 10a. Therefore, corrosion and breakage of the conductive portions due to electrolysis of the droplets 13 do not occur, whereby the semiconductor hydrogen pressure sensor 100 having high accuracy and high reliability while having a reduced size and a reduced weight can be obtained. In the present embodiment, since the protection film 12 continuously coats parts of the semiconductor pressure detection element 3, the bonding wires 10, the ASIC 9, and the pressure-reception chamber 7 that are exposed to the measurement target medium, the inside of the pressure-reception chamber 7 is effectively protected from condensation, whereby the semiconductor hydrogen pressure sensor 100 having high accuracy and high reliability can be obtained.

### Fuel Cell System 1000

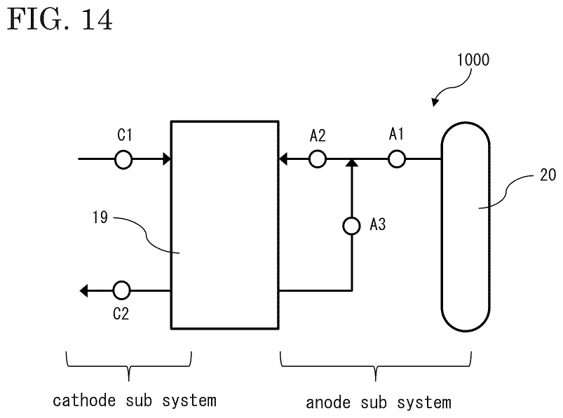

The relationship between droplets and a part in a fuel cell system 1000 where the semiconductor hydrogen pressure sensor 100 described in the present embodiment is applied, will be described with reference to FIG. 14. FIG. 14 is a schematic diagram schematically showing a gas supply system of the typical PEFC fuel cell system 1000, and relevant accessories are not shown. The composition and the state of the medium as a measurement target for the semiconductor hydrogen pressure sensor 100 greatly differ depending on the configuration of the fuel cell system 1000 and a measurement position of the semiconductor hydrogen pressure sensor 100.

The fuel cell system 1000 is composed of an anode sub system and a cathode sub system. The anode sub system supplies hydrogen from a hydrogen fuel tank 20 to a fuel cell stack 19. The cathode sub system supplies air from outside to the fuel cell stack 19, and discharges water or vapor produced through reaction from the fuel cell stack 19 to outside. Arrows shown in FIG. 14 indicate the directions in which the medium flows. In the anode sub system, pure hydrogen stored in the hydrogen fuel tank 20 is supplied to the fuel cell stack 19. Unreacted hydrogen, a part of vapor produced through reaction, and the like are merged with pure hydrogen supplied from the hydrogen fuel tank 20 and are supplied to the fuel cell stack 19 again, so as to recirculate to the fuel cell stack 19. On the other hand, in the cathode sub system, water and vapor which are by-products produced through reaction are discharged to outside without recirculating.

In this fuel cell system 1000, in a case where the semiconductor hydrogen pressure sensor 100 is provided at an A1 part in the anode sub system, the measurement target medium for the semiconductor hydrogen pressure sensor 100 is hydrogen gas supplied from the hydrogen fuel tank 20. The measurement target medium at the A1 part is hydrogen gas having purity of almost 100%, and other gas components such as vapor are not contained in the measurement target medium. Therefore, droplets which become a problem are not deposited on the semiconductor hydrogen pressure sensor 100 designed and manufactured so as to have sufficient hydrogen reliability.

In a case where the semiconductor hydrogen pressure sensor 100 is provided at an A2 part or an A3 part in the anode sub system, the measurement target medium for the semiconductor hydrogen pressure sensor 100 contains hydrogen as a main component, but is hydrogen containing a certain amount of vapor. The A2 part of the A3 part is a part where the semiconductor hydrogen pressure sensor 100 is provided in a path through which recirculation is performed as described above. Therefore, vapor contained in the measurement target medium condenses on the surfaces of the semiconductor pressure detection element 3, the ASIC 9, the bonding wires 10, and the like due to a difference between the medium temperature and each temperature of the above members, under a specific complex condition. In addition, depending on the operation state of the system, a medium containing a droplet might flow in the path through which recirculation is performed. For example, at the position of the A3 part, there is a case where droplets are not completely removed depending on designing or operation of a gas-liquid separator (not shown). In addition, at the position of the A2 part, the medium returned through the recirculation path and having a relatively high temperature and a relative high humidity merges with dry hydrogen supplied from the hydrogen fuel tank 20 and having a relatively low temperature, so that the medium flowing in from the recirculation path side is sharply cooled. Thus, condensation is likely to occur on the semiconductor hydrogen pressure sensor 100 and droplets which become a problem might be deposited on the semiconductor hydrogen pressure sensor 100.

In a case where the semiconductor hydrogen pressure sensor 100 is provided at a C1 part in the cathode sub system, the measurement target medium for the semiconductor hydrogen pressure sensor 100 is basically air taken in from the outside air. However, under a specific condition, there is a case where hydrogen gas passes through the fuel cell stack 19 from the anode side and spreads. Therefore, for measuring a pressure, certain hydrogen resistance is needed, and thus the semiconductor hydrogen pressure sensor 100 is used also at the C1 part. Although the semiconductor hydrogen pressure sensor 100 is used, droplets which become a problem are not deposited on the semiconductor hydrogen pressure sensor 100.

In a case where the semiconductor hydrogen pressure sensor 100 is provided at a C2 part in the cathode sub system, the measurement target medium for the semiconductor hydrogen pressure sensor 100 is gas containing water or vapor produced as a by-product of reaction and discharged from the fuel cell stack 19. The C2 part is a part where droplets which become a problem are most likely to be deposited on the semiconductor hydrogen pressure sensor 100. The C2 part is a place where water which is a by-product of reaction is produced as a principle of a fuel cell. Unless a special measure such as purging is taken, the medium has a high humidity of 90% or more almost at all times during operation of the system, and the medium is partially changed into droplets. Therefore, at all times, it is necessary to assume a situation in which the droplets 13 are deposited on the surfaces of the semiconductor pressure detection element 3, the ASIC 9, and the bonding wires 10, as shown in FIG. 3.

As described above, in the case where the semiconductor hydrogen pressure sensor 100 is provided at the A2 part, the A3 part, or the C2 part, condensation is likely to occur on the semiconductor hydrogen pressure sensor 100, so that droplets which become a problem are deposited on the semiconductor hydrogen pressure sensor 100. Unlike the semiconductor hydrogen pressure sensor 101 in the comparative example shown in FIG. 12, in the present embodiment, the protection film 12 is provided on the surfaces of the semiconductor pressure detection element 3, the ASIC 9, and the bonding wires 10. Therefore, even if condensation has occurred on the semiconductor hydrogen pressure sensor 100 and droplets are present, since the droplets and the conductive portions are physically and electrically insulated from each other, electrolysis does not occur in the droplets and corrosion does not occur, thus obtaining a significant reliability improvement effect. Even in a situation in which the fuel cell system 1000 is operating and power is being supplied to the semiconductor hydrogen pressure sensor 100, the reliability improvement effect can be obtained in the same manner.

### Method for Manufacturing Semiconductor Hydrogen Pressure Sensor 100

A method for manufacturing the semiconductor hydrogen pressure sensor 100 will be described with reference to FIG. 4. The method for manufacturing the semiconductor hydrogen pressure sensor 100 includes a member preparation step (S11), a connection step (S12), and a film formation step (S13).

The details of each step will be described. The member preparation step is a step of preparing the bonding wires 10 and the semiconductor pressure detection element 3 which receives the pressure of the measurement target medium and electrically outputs a value according to the absolute pressure of the measurement target medium. The semiconductor hydrogen pressure sensor 100 shown in FIG. 1 further includes the ASIC 9, the lead frame 11, the pressure-reception chamber 7, the terminal 6, the O rings 8a and 8b, and the connecting pipe 2, and therefore these are also prepared in this step.

The connection step is a step of electrically connecting the bonding wire 10a to the semiconductor pressure detection element 3. Prior to the connection step, the pressure-reception chamber 7 into which the measurement target medium is taken is formed around the lead frame 11 by insert molding. In forming the pressure-reception chamber 7, a part of the lead frame 11 to be connected to the bonding wire 10b is exposed to outside. After the semiconductor pressure detection element 3 and the ASIC 9 are fixed inside the pressure-reception chamber 7, the semiconductor pressure detection element 3 and the ASIC 9 are connected by the bonding wire 10a, and the ASIC 9 and a part of the lead frame 11 that is exposed to outside are connected by the bonding wire 10b. As shown in FIG. 2, the semiconductor pressure detection element 3 and the ASIC 9 are arranged side by side and fixed on the surface of the lead frame 11 on the pressure-reception chamber 7 side via resin. A method for fixation is adhesion, for example, The film formation step is a step of continuously coating parts of the semiconductor pressure detection element 3 and the bonding wire 10a that are exposed to the measurement target medium, with the protection film 12. In the present embodiment, the protection film 12 continuously coats parts of the semiconductor pressure detection element 3, the bonding wires 10, the ASIC 9, and the pressure-reception chamber 7 that are exposed to the measurement target medium. The protection film 12 is a polymer coating film, for example, and is formed by chemical vapor deposition.

After the film formation step, the terminal 6 is electrically connected to the lead frame 11 by solder, for example. Next, the housing 1 is formed around the pressure-reception chamber 7 by insert molding, Next, a part of the housing 1 around the pressure-reception chamber 7, the pressure-reception chamber 7, and the connecting pipe 2 are connected via the O ring 8a. An external flow path (not shown) for the measurement target medium is connected to the connecting pipe 2 via the O ring 8b. Through these steps, the semiconductor hydrogen pressure sensor 100 shown in FIG. 1 is manufactured.

Since the semiconductor hydrogen pressure sensor 100 is manufactured as described above, even if condensation has occurred on the protection film 12, the droplets 13 are not deposited on the conductive portions of the semiconductor pressure detection element 3 and the bonding wire 10a. Therefore, corrosion and breakage of the conductive portions due to electrolysis of the droplets 13 do not occur, whereby the semiconductor hydrogen pressure sensor 100 having high accuracy and high reliability while having a reduced size and a reduced weight can be manufactured.

As described above, the semiconductor hydrogen pressure sensor 100 according to embodiment 1 includes; the semiconductor pressure detection element 3 which receives the pressure of the measurement target medium containing hydrogen and electrically outputs a value according to the absolute pressure of the measurement target medium; the bonding wire 10a extending from the terminal of the semiconductor pressure detection element 3; and the protection film 12 continuously coating parts of the semiconductor pressure detection element 3 and the bonding wire 10a that are exposed to the measurement target medium. Thus, even if condensation has occurred on the protection film 12, the droplets 13 are not deposited on the conductive portions of the semiconductor pressure detection element 3 and the bonding wire 10a. Therefore, corrosion and breakage of the conductive portions due to electrolysis of the droplets 13 do not occur, whereby the semiconductor hydrogen pressure sensor 100 having high accuracy and high reliability while having a reduced size and a reduced weight can be obtained.

The protection film 12 may continuously coat parts of the semiconductor pressure detection element 3, the bonding wires 10, the ASIC 9, and the pressure-reception chamber 7 that are exposed to the measurement target medium. Thus, the inside of the pressure-reception chamber 7 is effectively protected from condensation, whereby the semiconductor hydrogen pressure sensor 100 having high accuracy and high reliability can be obtained. The protection film 12 may be a polymer coating film. Thus, since the polymer coating film has functions such as repelling water, not allowing passage of vapor, and resisting acid corrosion, even if condensation has occurred on the protection film 12, the droplets 13 are assuredly prevented from being deposited on the conductive portions of the semiconductor pressure detection element 3 and the bonding wire 10a. Therefore, corrosion and breakage of the conductive portions due to electrolysis of the droplets 13 do not occur, whereby the semiconductor hydrogen pressure sensor 100 having high accuracy and high reliability can be obtained.

The method for manufacturing the semiconductor hydrogen pressure sensor 100 according to embodiment 1 includes: a member preparation step of preparing the bonding wire 10a and the semiconductor pressure detection element 3 which receives the pressure of the measurement target medium and electrically outputs a value according to the absolute pressure of the measurement target medium; the connection step of electrically connecting the bonding wire 10a to the semiconductor pressure detection element 3; and the film formation step of continuously coating parts of the semiconductor pressure detection element 3 and the bonding wire 10a that are exposed to the measurement target medium, with the protection film 12. Thus, even if condensation has occurred on the protection film 12, the droplets 13 are not deposited on the conductive portions of the semiconductor pressure detection element 3 and the bonding wire 10a.

Therefore, corrosion and breakage of the conductive portions due to electrolysis of the droplets 13 do not occur, whereby the semiconductor hydrogen pressure sensor 100 having high accuracy and high reliability while having a reduced size and a reduced weight can be manufactured.

### Embodiment 2

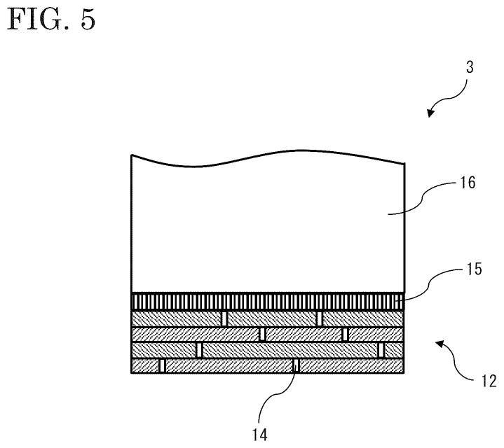

A semiconductor hydrogen pressure sensor 100 according to embodiment 2 will be described. FIG. 5 is a sectional view showing a major part of the pressure-reception chamber 7 of the semiconductor hydrogen pressure sensor 100 according to embodiment 2, in which a part of the semiconductor pressure detection element 3 on the measurement target medium side is shown in an enlarged manner and parts of a semiconductor base 16, a terminal 15, and the protection film 12 are shown, In the semiconductor hydrogen pressure sensor 100 according to embodiment 2, the protection film 12 has a laminated structure.

In the present embodiment, the protection film 12 is a laminated film in which a plurality of films are laminated. The reason for laminating the protection film 12 will be described. At a bonding pad part where the semiconductor pressure detection element 3 and the bonding wire 10a are electrically connected, or the like, there can be a part where the terminal 15 which is a conductive portion is exposed. As described in embodiment 1, basically, such a part is also coated with the protection film 12 formed conformally. However, in an actual manufacturing process, minute flaws 14 like pinholes might be produced in the protection film 12, and it is very difficult to completely prevent production of the flaws 14. If such flaws 14 are produced at a conductive part such as the terminal 15 so that the terminal 15 communicates with outside, a circuit via an entered droplet is formed at the part of the flaws 14 when power is supplied, so that electrolysis can occur in the droplet.

In the case where the protection film 12 is formed as a laminated film in which a plurality of films are laminated, as shown in FIG. 5, the protection film 12 can be laminated so that the flaws 14 are not connected to each other. Since the flaws 14 are not connected to each other, the terminal 15 can be prevented from communicating with outside via the flaws 14. The protection film 12 to be laminated may be the same as in embodiment 1. If a thick film is continuously formed at once, there is a high risk that the flaws 14 will communicate with each other. Therefore, during film formation, the film formation is stopped once and then the film formation is restarted, for example, to form a laminated structure, whereby the structure of the protection film 12 in which the flaws 14 do not communicate with outside can be formed, During film formation, a flaw 14 is produced at a certain probability, but the flaws 14 will never penetrate the entire protection film 12 unless the flaws 14 are produced at the same position so as to overlap and connect to each other every time a film is laminated. That is, the probability that the flaws 14 penetrating the protection film 12 are formed is proportional to a product of the probabilities that the flaws 14 are produced in respective laminated films, and therefore, as the number of laminated films increases, the probability that the flaws 14 penetrating the protection film 12 are produced can be significantly decreased. In actuality, the number of laminated films of the protection film 12 may be selected as appropriate in a range from several films to ten films, in consideration of the entire thickness of the protection film 12 and residual stress therein.

As described above, in the semiconductor hydrogen pressure sensor 100 according to embodiment 2, the protection film 12 is a laminated film in which a plurality of films are laminated. Thus, even if minute flaws 14 such as pinholes are present in the protection film 12 provided on the semiconductor pressure detection element 3, the flaws 14 can be prevented from communicating with outside. Since the flaws 14 do not communicate with outside, it is possible to prevent a droplet from reaching the surface of the semiconductor pressure detection element 3 even if the measurement target medium is a high-humidity medium containing a large amount of vapor. Since a droplet does not reach the surface of the semiconductor pressure detection element 3, reliability of the semiconductor hydrogen pressure sensor 100 can be improved.

### Embodiment 3

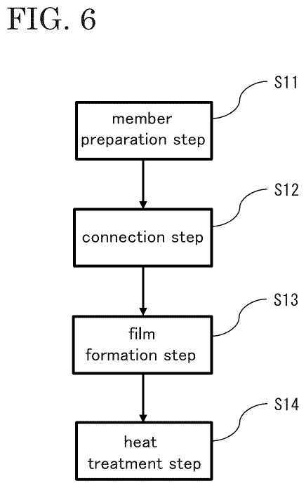

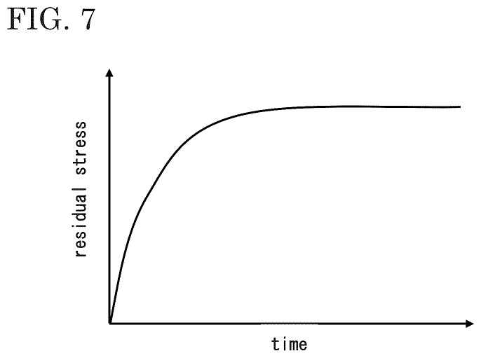

A method for manufacturing a semiconductor hydrogen pressure sensor 100 according to embodiment 3 will be described. FIG. 6 shows a manufacturing process for the semiconductor hydrogen pressure sensor 100 according to embodiment 3, and FIG. 7 shows change in residual stress in a case where the protection film 12 of the semiconductor hydrogen pressure sensor 100 is placed under a certain high-temperature environment. In the method for manufacturing the semiconductor hydrogen pressure sensor 100 according to embodiment 3, a heat treatment step is added. The protection film 12 of the semiconductor hydrogen pressure sensor 100 according to embodiment 3 has undergone heat treatment.

The method for manufacturing the semiconductor hydrogen pressure sensor 100 further includes a heat treatment step (S14) of performing heat treatment at a part of the protection film 12 after the film formation step (S13) described in embodiment 1, as shown in FIG. 6. The reason for adding the heat treatment step will be described. As 1.5 described in embodiment 1, the protection film 12 is a parylene film, for example. The parylene film, though depending on the kind thereof, has a characteristic that residual stress changes with application time, as shown in FIG. 7, even in a case of about 100° C. which is approximately the maximum temperature of a medium used in the PEFC fuel cell system. That is, residual stress increases with time until a certain time, but after that, the change amount of residual stress is saturated so as to be stabilized.

If such an event that residual stress of the protection film 12 changes occurs in the manufacturing process for the semiconductor hydrogen pressure sensor 100, deviation from the detection characteristic that should be originally provided occurs in the semiconductor hydrogen pressure sensor 100, so that measurement accuracy of the semiconductor hydrogen pressure sensor 100 is reduced. As another case, if such an event that residual stress of the protection film 12 changes occurs after operation of the fuel Cell system 1000 is started, the detection characteristic of the semiconductor hydrogen pressure sensor 100 changes during usage of the semiconductor hydrogen pressure sensor 100. In any case, high-accuracy measurement by the semiconductor hydrogen pressure sensor 100 is hampered.

In the manufacturing process for the semiconductor hydrogen pressure sensor 100, immediately after the protection film 12 is formed, heat treatment is performed during a period until residual stress in FIG. 7 reaches a stable region, whereby it is possible to prevent hampering of high-accuracy measurement by the semiconductor hydrogen pressure sensor 100. Specifically, it is preferable that the protection film 12 is aged through heat treatment at 130° C. for about 10 hours. The applied temperature may be set to be slightly higher than a temperature region used for the actual system, whereby the heat treatment time can be shortened. In addition, response of the protection film 12 to a high temperature in actual usage is reduced, whereby change in the semiconductor hydrogen pressure sensor 100 over time can be suppressed. Thus, it is possible to maintain a stable detection characteristic of the semiconductor hydrogen pressure sensor 100 over the expected lifespan of the fuel cell system 1000.

As described above, the method for manufacturing the semiconductor hydrogen pressure sensor 100 according to embodiment 3 further includes a heat treatment step of performing heat treatment at a part of the protection film 12 after the film formation step. Thus, residual stress that the protection film 12 has is stabilized in a state of not being changed by an external factor such as a high temperature, so that the detection characteristic of the semiconductor hydrogen pressure sensor 100 does not change any longer and high measurement accuracy that the semiconductor hydrogen pressure sensor 100 has can be maintained over the expected assurance period. In addition, since the protection film 12 of the semiconductor hydrogen pressure sensor 100 according to embodiment 3 has undergone heat treatment, the detection characteristic of the semiconductor hydrogen pressure sensor 100 does not change any longer, so that high measurement accuracy that the semiconductor hydrogen pressure sensor 100 has can be maintained over the expected assurance period.

### Embodiment 4

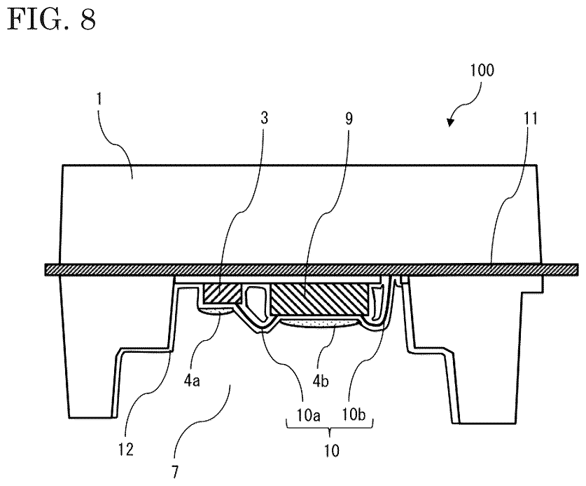

A semiconductor hydrogen pressure sensor 100 according to embodiment 4 will be described. FIG. 8 is a sectional view schematically showing the pressure-reception chamber 7 of the semiconductor hydrogen pressure sensor 100 according to embodiment 4. In the semiconductor hydrogen pressure sensor 100 according to embodiment 4, a gel-like member is added.

In the present embodiment, the surface of the protection film 12 coating the semiconductor pressure detection element 3 is covered with a gel-like member. As shown in FIG. 8, gel 4a is provided on the surface of the protection film 12 coating the semiconductor pressure detection element 3, and gel 4b is provided on the surface of the protection film 12 coating the ASIC 9. The gel-like member is silicone gel, for example. The reason for adding the gel-like member will be described below.

As described above, since the protection film 12 is provided on the surfaces of the conductive portions inside the pressure-reception chamber 7, even if droplets due to condensation are produced on the protection film 12 and power is supplied to the semiconductor hydrogen pressure sensor 100 during system operation, electrolysis does not occur in the droplets. However, in the configuration shown in FIG. 2, the gel 4 is not used and thus a shock mitigation effect that the gel 4 has is not obtained. That is, the gel 4 also has a function of preventing the pressure-reception diaphragm or the like present at the surface of the semiconductor pressure detection element 3 from being physically damaged by shock when a solid foreign material or the like collides with the semiconductor pressure detection element 3 at a high speed.

Since the gel-like member is added on the surface of the protection film 12 coating the semiconductor pressure detection element 3, the semiconductor pressure detection element 3 can be prevented from being physically damaged by collision of a foreign material. In the fuel cell system 1000, a large number of very fine flow paths are provided inside the fuel cell stack 19, and in order to prevent these flow paths from being clogged by foreign materials and prevent a foreign material from entering the gas supply system, a filter is provided at the flow path for the medium. Therefore, large foreign materials as in a pipe of an internal combustion engine are not present in a large number, but minute solid foreign materials might be mixed in a certain amount in the flow path. In view of such a usage environment, for shock mitigation, it is not necessary to use a large amount of gel as shown in FIG. 12 which is the comparative example, and it is appropriate to use a proper amount of gel for only a necessary part.

As described above, in the semiconductor hydrogen pressure sensor 100 according to embodiment 4, the surface of the protection film 12 coating the semiconductor pressure detection element 3 is covered with the gel-like member. Thus, it is possible to prevent the pressure-reception diaphragm of the semiconductor pressure detection element 3 from being damaged by shock of collision of a particle-like foreign material or the like entering from outside.

### Embodiment 5

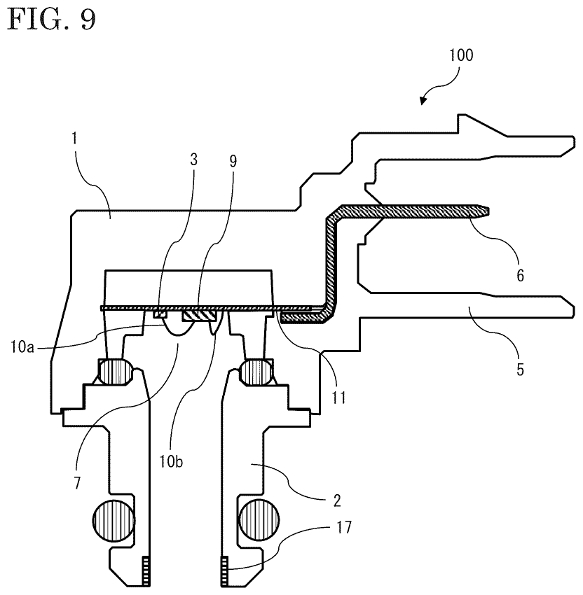

A semiconductor hydrogen pressure sensor 100 according to embodiment 5 will be described. FIG. 9 is a sectional view schematically showing the semiconductor hydrogen pressure sensor 100 according to embodiment 5 with the protection film 12 not shown. In the semiconductor hydrogen pressure sensor 100 according to embodiment 5, the connecting pipe 2 has a hygroscopic member 17.

In the present embodiment, the connecting pipe 2 has the hygroscopic member 17 at an end of the connecting pipe 2 through which the measurement target medium is taken in. The hygroscopic member 17 is provided around the entire circumference of an inner wall surface at the end of the connecting pipe 2, for example, in a state of being allowed to contact with the measurement target medium. The hygroscopic member 17 is silica gel which adsorbs water, for example. With this configuration, vapor contained in the measurement target medium is trapped by the hygroscopic member 17 before reaching the pressure-reception chamber 7 where the semiconductor pressure detection element 3 and the like are provided. Thus, moisture reaching the pressure-reception chamber 7 can be reduced. Since moisture reaching the pressure-reception chamber 7 is reduced, condensation in the pressure-reception chamber 7 and malfunction caused by condensation can be suppressed, whereby reliability of the semiconductor hydrogen pressure sensor 100 can be further improved.

As described above, in the semiconductor hydrogen pressure sensor 100 according to embodiment 5, the connecting pipe 2 has the hygroscopic member 17 at the end of the connecting pipe 2 through which the measurement target medium is taken in. Thus, even if droplets and vapor are contained in a large amount in the measurement target medium, these are absorbed by the hygroscopic member 17, whereby the amount of droplets and vapor reaching the pressure-reception chamber 7 can be significantly reduced. Since the amount of droplets and vapor reaching the pressure-reception chamber 7 is significantly reduced, it is possible to significantly reduce a risk of condensation and corrosion of conductive portions through electrolysis due to condensation under a specific complex environment.

### Embodiment 6

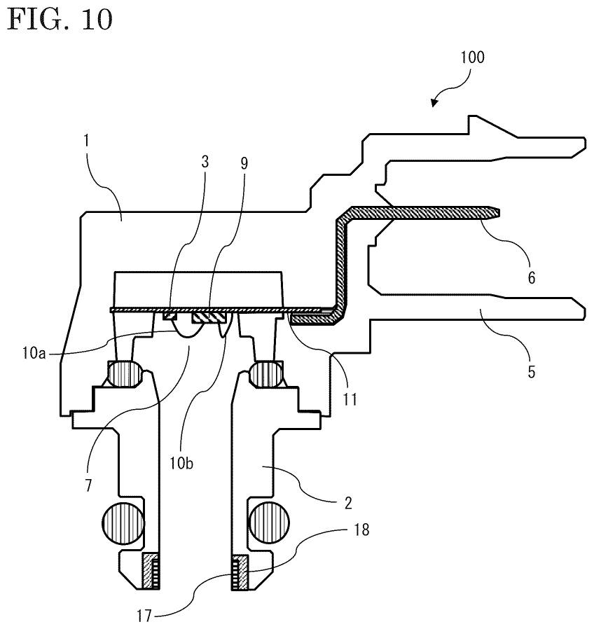

A semiconductor hydrogen pressure sensor 100 according to embodiment 6 will be described. FIG. 10 is a sectional view schematically showing the semiconductor hydrogen pressure sensor 100 according to embodiment 6 with the protection film 12 not shown. In the semiconductor hydrogen pressure sensor 100 according to embodiment 6, the connecting pipe 2 has a heating portion 18.

In the present embodiment, the connecting pipe 2 has the heating portion 18 adjacent to the hygroscopic member 17. The heating portion 18 is provided so as to surround the hygroscopic member 17, for example. The heating portion 18 is a heater of which the temperature is electrically increased, for example. The reason for adding the heating portion 18 will be described below.

As described above, by providing the hygroscopic member 17 at the end of the connecting pipe 2, the amount of vapor reaching the pressure-reception chamber 7 is reduced, whereby reliability of the semiconductor hydrogen pressure sensor 100 can be improved. However, it is often difficult to continue having this effect over the expected lifespan of the fuel cell system 1000, though depending on the system operation condition or the like. This is because the moisture absorbing amount of the hygroscopic member 17 is limited.

By providing the heating portion 18 adjacent to the hygroscopic member 17, it is possible to release vapor absorbed by the hygroscopic member 17 through driving of the heating portion 18 as a part of a series of sequential operations when the fuel cell system 1000 is stopped, for example. Subsequent to release of vapor, purging is performed, whereby the released vapor is discharged to outside so as not to stay in the pressure-reception chamber 7, and thus the inside of the connecting pipe 2 and the inside of the pressure-reception chamber 7 can be made into a dry environment. In addition, the moisture absorbing function of the hygroscopic member 17 can be restored. Thus, the semiconductor hydrogen pressure sensor 100 having stable reliability over a long period can be obtained.

As described above, in the semiconductor hydrogen pressure sensor 100 according to embodiment 6, the connecting pipe 2 has the heating portion 18 adjacent to the hygroscopic member 17. Thus, moisture absorbed by the hygroscopic member 17 can be vaporized, whereby the reduced moisture absorbing ability of the hygroscopic member 17 can be restored. Since the moisture absorbing ability of the hygroscopic member 17 is restored, the semiconductor hydrogen pressure sensor 100 can continue maintaining high reliability over a long period even if the measurement target medium has a high humidity.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 housing
2 connecting pipe
3 semiconductor pressure detection element
4, 4a, 4b gel
5 connector portion
6 terminal
7 pressure-reception chamber
7a opening
8a, 8b O ring
9 ASIC
10, 10a, 10b bonding wire
11 lead frame
12 protection film
13 droplet
14 flaw
15 terminal
16 semiconductor base
17 hygroscopic member
18 heating portion
19 fuel cell stack
20 hydrogen fuel tank
100, 101 semiconductor hydrogen pressure sensor
1000 fuel cell system

1. A semiconductor hydrogen pressure sensor comprising:
a semiconductor pressure detection element which receives a pressure of a measurement target medium containing hydrogen and electrically outputs a value according to an absolute pressure of the measurement target medium;
a bonding wire extending from a terminal of the semiconductor pressure detection element; and
a protection film continuously coating parts of the semiconductor pressure detection element and the bonding wire that are exposed to the measurement target medium.

2. The semiconductor hydrogen pressure sensor according to claim 1, wherein
the protection film is a laminated film in which a plurality of films are laminated.

3. The semiconductor hydrogen pressure sensor according to claim 1, wherein
a surface of the protection film coating the semiconductor pressure detection element is covered with a gel-like member.

4. The semiconductor hydrogen pressure sensor according to claim 1, further comprising:
a pressure-reception chamber inside which the semiconductor pressure detection element is fixed and which has an opening through which the measurement target medium is taken into the pressure-reception chamber; and
a connecting pipe which communicates with the pressure-reception chamber via the opening and through which the measurement target medium is taken into the pressure-reception chamber from outside, wherein
the connecting pipe has a hygroscopic member at an end of the connecting pipe through which the measurement target medium is taken in.

5. The semiconductor hydrogen pressure sensor according to claim 4, wherein
the connecting pipe has a heating portion adjacent to the hygroscopic member.

6. The semiconductor hydrogen pressure sensor according to claim 1, further comprising:
a pressure-reception chamber which is made of resin and inside which the semiconductor pressure detection element is fixed;
a lead frame insert-molded in the pressure-reception chamber; and
a signal processing circuit which is fixed inside the pressure-reception chamber and which is connected to the semiconductor pressure detection element via the bonding wire and connected to the lead frame, wherein
the protection film continuously coats parts of the semiconductor pressure detection element, the bonding wire, the signal processing circuit, and the pressure-reception chamber that are exposed to the measurement target medium.

7. The semiconductor hydrogen pressure sensor according to claim 1, wherein
the protection film is a polymer coating film.

8. The semiconductor hydrogen pressure sensor according to claim 7, wherein
the protection film has undergone heat treatment.

9. A method for manufacturing a semiconductor hydrogen pressure sensor, comprising:
a member preparation step of preparing a bonding wire and a semiconductor pressure detection element which receives a pressure of a measurement target medium and electrically outputs a value according to an absolute pressure of the measurement target medium;
a connection step of electrically connecting the bonding wire to the semiconductor pressure detection element; and
a film formation step of continuously coating parts of the semiconductor pressure detection element and the bonding wire that are exposed to the measurement target medium, with a protection film.

10. The method for manufacturing the semiconductor hydrogen pressure sensor according to claim 9, further comprising a heat treatment step of performing heat treatment at a part of the protection film after the film formation step.
